(19) United States
(12) Patent Application Publication
(10) Pub. No.: US 2015/0074765 A1
(43) Pub. Date: Mar. 12, 2015

(54) REGISTRATION AND CONFIGURATION OF POINT-OF-SERVICE DEVICES

(71) Applicant: Oracle International Corporation, Redwood Shores, CA (US)

(72) Inventors: Ronald W. Haight, Pflugerville, TX (US); Brett J. Larsen, Austin, TX (US); Tony M. Zgarba, Austin, TX (US); Christian M. Greene, Austin, TX (US)

(73) Assignee: Oracle International Corporation, Redwood Shores, CA (US)

(21) Appl. No.: 14/229,283

(22) Filed: Mar. 28, 2014

Related U.S. Application Data
(60) Provisional application No. 61/874,789, filed on Sep. 6, 2013.

(51) Int. Cl. H04L 29/06

(52) U.S. Cl. CPC H04L 63/10; H04L 63/083
USPC 726/4

(57) ABSTRACT

A method, apparatus, and computer readable storage medium are disclosed for registration and configuration of point-of-service (POS) devices. The method includes using a device identifier in determining whether a device is authorized to access a retail point-of-service application. In response to a determination that the device is authorized, the method includes allowing the device access to the POS application and providing the device with application profile information for the POS application. The apparatus includes a processor, a network interface configured for communication with a POS device, and a POS interface application configured to use a device identifier in determining whether a device is authorized to access a retail POS application. The non-transitory computer readable storage medium is configured to store program instructions that when executed are configured to cause a processor to perform the method.

### RELATED APPLICATION

This application claims domestic benefit under Title 35 of the United States Code §119(e) of U.S. Provisional Patent Application Ser. No. 61/874,789, entitled “Mobile Point-of-Service Device Registration,” filed Sep. 6, 2013, and naming Ronald W. Haight, Brett J. Larsen, Tony M. Zgarba, and Christian M. Greene as inventors, which is incorporated by reference herein in its entirety and for all purposes as if completely and fully set forth herein.

### TECHNICAL FIELD

This application relates to retail point-of-service software and systems, and more particularly to registration and configuration of point-of-service devices.

### DESCRIPTION OF THE RELATED ART

A Point of Service (POS), also called Point of Sale, is the place where a retail transaction between a customer and a merchant is completed. At the POS, traditionally, a clerk uses a cash register, or a comparable POS terminal or device, to allow the customer to make a payment to the merchant in exchange for goods and/or services. The register or other POS device is used, for example, to calculate the amount owed by the customer for the goods and/or services in question. The merchant also will provide options as to the form of payment used by the customer to pay for the goods and/or services. Once the payment is completed, a receipt for the transaction is issued. POS devices can provide this register functionality, as well as additional item, inventory, or customer functionality, such as promotions, discounts, customer-specific pricing, and item availability in the same location or other locations.

Mobile POS (MPOS) devices, which are untethered from the cashier lanes, are useful for retailers who desire more personalized customer interaction, such as with regard to lifestyle and fashion brands, or who wish to reduce long customer wait times that can occur in various situations, such as during peak hours or holidays. The MPOS device may be a specialized mobile terminal integrating features such as a keypad, card reader, display, processor and wireless communications transceiver. Alternatively, the MPOS device may be a combination of a smartphone or other personal wireless device with a shell or “sled” containing retail-specific features such as a card reader.

Although MPOS devices can provide advantages over stationary registers in terms of, for example, flexibility and cost, they present security challenges. The portability of a mobile device can make it easier to steal, and systems accessible through wireless communications can be vulnerable to “spoofing” attacks in which an unauthorized mobile device represents itself as an authorized device to gain access to the system and its data. When an MPOS device is based on a commonly-available consumer wireless device for which technical information (authorized or otherwise) may be widely disseminated, such spoofing attempts may be even more likely.

Unauthorized access is of particular concern when a point-of-service system is connected to an enterprise software application or applications suite, such as customer relationship management (CRM) software. Although direct customer financial data such as credit card numbers is typically protected by measures including strong encryption schemes and prohibitions from storage, access to a retail enterprise application can nonetheless expose commercially sensitive data, such as that relating to inventory, discounts, customer lists and customer buying habits.

In light of the foregoing, it is desirable to reduce the vulnerability of point-of-service applications and associated enterprise software to unauthorized access using mobile devices.

### SUMMARY

In various embodiments described herein, disclosed are methods, software programs and systems for preventing access to a point-of-service application by unauthorized devices. In an embodiment, the devices are mobile devices, but the methods, programs and systems described herein can also be applied to fixed point-of-service devices. More particularly, methods, software programs and systems are disclosed for associating a device with device profile information at the application level. This is in contrast to the traditional approach for enterprise software, in which application level profiles are associated with the individual user, with little attention to the device used. In an embodiment, a unique identifier (ID) for the point-of-service device is stored so that the device can be authenticated in conjunction with user login by sending the unique ID for verification along with a username and password entered by the user. In some embodiments the unique ID is transmitted or stored in a hashed or otherwise altered form. In an embodiment, the association of the device with an application profile is accomplished by a system administrator through a web application. In such an embodiment, the administrator can view the registered devices, add or remove devices, and change the associated application profile.

The terms “application profile” and “device profile” are used interchangeably herein to reference profile information for a particular device as used in connection with an application program, such as a retail point-of-service application. From the standpoint of a device, “application profile” may conveniently describe a set of information associating that device with an application program, while from the standpoint of the application, “device profiles” may better describe the multiple sets of information associating respective multiple devices with the application.

In embodiments described herein, device profile information is used by a point-of-service interface server to authenticate a device that attempts connection to a retail point-of-service application. If a POS interface server is unsuccessful either in authenticating the user or authenticating the specific device used for user login, the server denies access to the application by the device. In this way, an unauthorized user cannot access the application with even an authorized device, and even an authorized user cannot access the application with an unregistered device, such as a personally-owned telephone or music player. If an authorized device is stolen, the retailer can unregister the device by removing it from the application's list of authorized devices, either manually or automatically.

An embodiment of the methods described herein includes receiving a device identifier configured to uniquely identify a POS device and using the device identifier in determining whether the device is authorized to access a retail point of service application. In response to a determination that the device is authorized, the method in this embodiment further includes allowing the device to access the POS application and providing the device with application profile information for the POS application, where the application profile information is specific to the POS device.

In certain embodiments of the methods, software programs and systems disclosed herein the association of devices with device profile information in a point-of-service application is implemented at the individual retail store level using a server associated with the store. In some embodiments, this registration of mobile devices is independent of registration of authorized users, which may be implemented at the enterprise level. In some cases, factors such as the number of employees or the rate of employee turnover in a retail store can make association of specific users with application profile information at the store level burdensome for retailers.

The application accessed by the point-of-service devices is a web application in certain embodiments, and in such embodiments the unique ID for a device is passed to a web server during the user login process. In such embodiments, a web session is created if the unique ID for the device matches a device ID registered with the web application, and the application profile information is “attached” to the web session through storage into session storage space assigned to the registered device. In addition to a mapping of the device ID to the appropriate store number and to a register number recognized by the POS application, the application profile information in certain embodiments includes settings for operation of the device during the web session.

An embodiment of the systems described herein is an apparatus including a processor, a network interface configured for communication with a POS device, and a POS interface application configured to receive a device identifier configured to uniquely identify a POS device and use the device identifier in determining whether the device is authorized to access a retail POS application. In response to a determination that the device is authorized, the POS interface application in this embodiment is further configured to allow the device to access the POS application and provide the device with application profile information for the POS application, where the application profile information is specific to the POS device.

An embodiment of the software programs described herein is a non-transitory computer readable storage medium configured to store program instructions that, when executed on a processor, are configured to cause the processor to perform a method including receiving a device identifier configured to uniquely identify a POS device and using the device identifier in determining whether the device is authorized to access a retail point of service application. In response to a determination that the device is authorized, the method in this embodiment of the program instructions further includes allowing the device to access the POS application and providing the device with application profile information for the POS application, where the application profile information is specific to the POS device.

The foregoing is a summary and thus contains, by necessity, simplifications, generalizations and omission of detail; consequently those skilled in the art will appreciate that the summary is illustrative only and is not intended to be in any way limiting. Other aspects, inventive features, and advantages of the invention defined by the appended claims will become apparent in the non-limiting detailed description set forth below.

### BRIEF DESCRIPTION OF THE DRAWINGS

The present invention may be better understood, and its numerous objects, features and advantages made apparent to those skilled in the art by referencing the accompanying drawings.

FIG. 1 is a block diagram illustrating a point-of-service network for a retail store according to certain embodiments described herein.

FIG. 2 is a block diagram illustrating certain functions implemented by a point-of-service interface application according to certain embodiments described herein.

FIG. 3 is a flowchart of a point-of-service device access control method according to certain embodiments described herein.

FIG. 4 is a flowchart of a device application profile configuration method according to certain embodiments described herein.

FIG. 5 is a flowchart of a method for adding, removing, or changing the application profile data of a registered point-of-sale device.

FIG. 6 is a block diagram illustrating a network environment in which point-of-service transactions according to embodiments described herein may be practiced.

FIG. 7 is a block diagram illustrating a computer system suitable for implementing embodiments of point-of-service systems described herein.

FIG. 8 is a block diagram illustrating the interconnection of the computer system of FIG. 7 to client and host systems.

The use of the same reference symbols in different drawings indicates similar or identical items.

### DETAILED DESCRIPTION

The following is intended to provide a detailed description of an example of the invention and should not be taken to be limiting of the invention itself. Rather, any number of variations may fall within the scope of the invention which is defined in the claims following the description.

### Example Retail POS Network Architecture

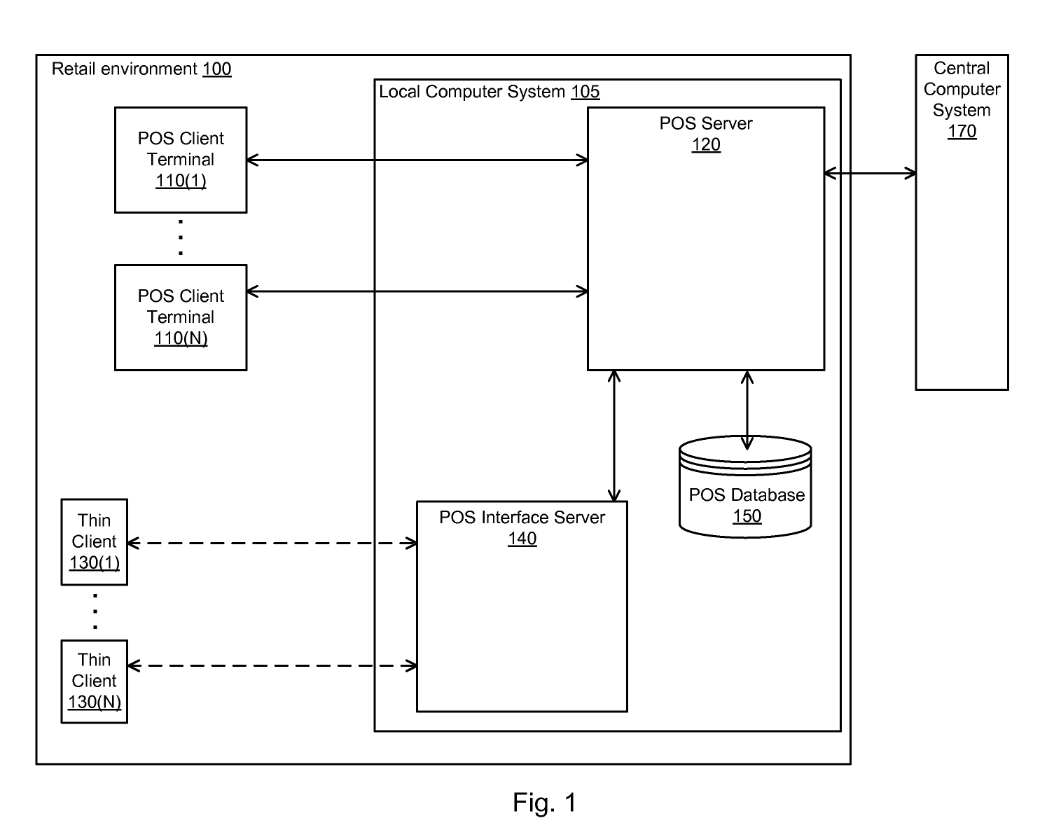

A block diagram illustrating an exemplary point-of-service system for a retail environment 100 is shown in FIG. 1. “Retail environment” as used herein refers to a store or other commercial location where goods or services are purchased, and is not intended to limit, for example, the type of customer or the pricing structure involved. In the embodiment of FIG. 1, a retail environment such as a store employs one or more POS client terminals or devices 110 that are configured to access a POS server application 120 and one or more thin client terminals or devices 130 configured to connect to POS interface server application 140. POS server 120 is stored on local computer system 105. In an embodiment, POS server 120 is a virtual computer such as a Java® Virtual Machine. POS server 120 accesses POS database 150 for data used in POS transactions, such as information on items, prices, promotions, and taxes. In the embodiment of FIG. 1, POS server 120 is connected over a network to central computer system 170, which may be connected to computers at multiple retail locations. In an embodiment, central computer system 170 is associated with a corporate data center. POS server 120 may form a part of an enterprise software suite including additional retail or corporate application programs. Other applications not shown in FIG. 1 that can be stored on embodiments of local computer system 105 or central computer system 170 include store management, financial analysis and reporting, corporate level management, and returns management. Such additional applications can be interconnected with or share data with POS server 120, and POS database 150 can form a portion of a database supporting other enterprise applications. In addition to central computer system 170, POS server 120 is in some embodiments connected to a wider network connecting additional store locations or other servers and clients within a larger enterprise application scheme.

POS client terminals 110 are fixed cash register terminals in some embodiments. Each of POS client terminals 110 runs a POS client application (not shown) configured to interact with POS server 120. In an embodiment, the POS client application runs within a virtual computer, such as a Java® Virtual Machine, on POS client terminal 110. A user or operator of a POS client terminal 110 may need to complete a login procedure with POS server 120 by entering a user identifier and password into the particular one of POS client terminals 110 to be used. Registration or authentication of POS client terminal 110 itself with POS server 120 is generally not required, however. In association with an installed POS client application, each of POS client terminals 110 may maintain POS-related data, which may include the terminal's register number as recognized by POS server 120 and a store identifier associated with local retail environment 100. In some embodiments, POS client terminals 110 also store data related to particular users and their roles, data which is also stored on local computer system 105. Such duplication of data also maintained by POS server 120 can allow operation of POS client terminals 110 in the event of a power outage (assuming battery backup of the terminal) or networking failure. In the embodiment of FIG. 1, POS client terminals 110 connect to local computer system 105 and POS server 120 through wired connections (such as electrical or optical cables) represented by solid lines in FIG. 1. Alternatively (or in some combination therewith), POS client terminals 110 could also connect to local computer system 105 using a wireless connection to a wireless access point (not shown) that facilitates such communications.

In addition to POS client terminals 110, thin client devices 130 are used as POS terminals in the embodiment of FIG. 1. The term “thin client” as used herein is consistent with its general usage in the computing and networking fields as a computing device that relies on a separate server computer for certain functions. In some embodiments, a “thin client” device is a device that does not include one or more modules provided on the local computer system, such as a POS interface server, a client interface module, an access control module and/or a session control module. Alternatively or in addition, a thin client device in certain embodiments does not include session storage space and/or device profile information such as mappings to register and store information or settings for use with a point of sale application.

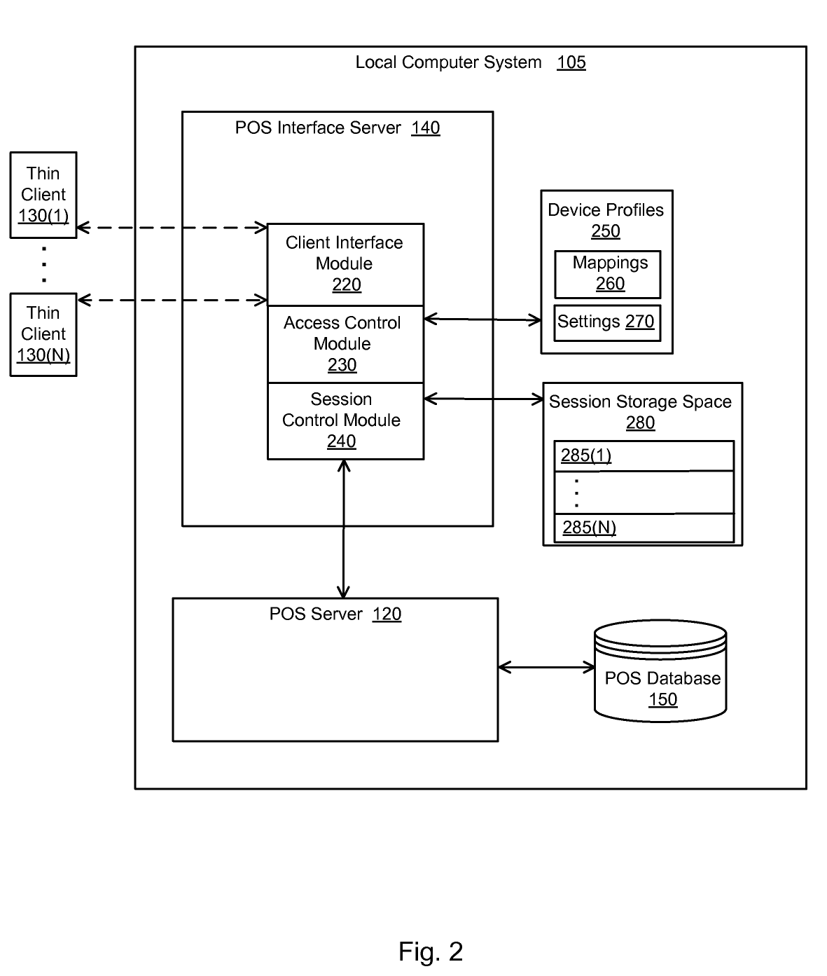

In some embodiments, a mobile device such as a smartphone or portable media player can be used to implement a thin client 130. Such a mobile device may be combined with a “sled” designed to fit under or around the mobile device and provide additional functions such as a card reader or numeric keypad. Alternatively, thin client 130 may be implemented using a larger device such as a computer or more traditional cash register terminal. However implemented, thin client 130 does not need to (and in some embodiments, cannot) run a POS client application configured to interact directly with POS server 120. Instead, thin client devices 130 interact with POS server 120 through POS interface server 140. As discussed further below with reference to FIG. 2, POS interface server 140 provides an interface between thin client devices 130 and POS server 120. Like POS server 120, POS interface server 140 is stored on local computer system 105 in the embodiment of FIG. 1. In some embodiments, POS interface server 140 is implemented as a virtual computer such as a Java® Virtual Machine. In an embodiment, POS interface server 140 receives a unique device identifier from each of thin client devices 130, and determines whether the respective device is authorized to access POS server 120. POS interface server may also determine whether the user or operator of the thin client device is an authorized user. In an embodiment, this user authentication includes passing a user identifier and password entered by the user to POS server 120.

In the embodiment of FIG. 1, a thin client device 130 executes a client application, in order to interact with POS interface server 140, but such a client application can be implemented in a significantly simpler manner than that run by POS client terminals 110. In some embodiments, thin client device 130 also does not need to maintain POS-related information such as the register number associated therewith by POS server 120, or the identifier of the store in which thin client devices 130 are being operated. This kind of information can instead be maintained by POS interface server 140 in an application profile for one of thin client devices 130, and provided to that one of thin client devices 130 upon successful authorization to access POS server 120. In the embodiment of FIG. 1, thin client devices 130 connect to local computer 105 and POS interface server 140 through wireless links represented by dashed lines. These devices can also be connected using wired connections, however. A mobile device used as a thin client can operate over a wired connection when “docked” into a larger terminal device, for example.

One potential benefit of using POS interface server 140 between a POS terminal such as one of thin client devices 130 and POS server 120 is improved security. Local computer system 105 including POS server 120, POS interface server 140, and database 150 can be located away from public areas of the store, providing some degree of security against direct viewing or copying of data, or at an off-site location, to provide additional security and protection. Use of POS interface server 140 to authenticate each of thin client devices 130, as well as its user, may reduce the likelihood of access, using unauthorized devices, to POS server 120 and its associated data. Although fixed computers or terminals are less likely than mobile devices to be stolen, use of such a device as a thin client device 130 may provide improved security in that less information is stored on the terminal, where it might be more easily observed or copied. Another potential benefit of using POS interface server 140 is that less capable POS terminal devices can be used, such as portable devices. Even when more capable terminals are used, the thin client arrangement described herein can provide greater configurability through the application profile information maintained by POS interface server 140 for each thin client terminal.

In the embodiment of FIG. 1, two of POS client terminals 110 and two of thin client devices 130 are explicitly shown, but different quantities may be used, including just one or any value of N. In some embodiments, a retail location can employ only thin client devices 130 without using POS client terminals 110. In such an embodiment, all POS terminals access POS server 120 through POS interface server 140, and these two servers could alternatively be implemented as a single thin-client POS server. Various alternatives to the layout of FIG. 1 may be apparent to one of ordinary skill in the art in view of the teachings of this disclosure. For example, one or more of POS server 120, POS interface server 140, and POS database 150 can in some embodiments be stored on a separate computer system from others of these elements.

The block diagram of FIG. 2 provides an illustration of certain functionality of POS interface server 140. In the embodiment of FIG. 2, the POS interface application implemented by POS interface server 140 includes client interface module 220, access control module 230, and session control module 240. Client interface module 220 interfaces with thin client devices 130. In an embodiment, client interface module 220 provides access to POS interface server 140 using a hypertext transfer protocol such as HTTP or HTTPS. In such an embodiment, client interface module 220 may provide an interface based on representational state transfer (REST). In an embodiment, such a REST-based interface may differ from traditional REST by not requiring the thin client devices to maintain state information. Such an embodiment can reduce the processing and storage capability required on thin client devices 130, potentially allowing a greater variety of devices to be used in implementing thin client devices 130. Moreover, in an embodiment for which POS interface server 140 appears as a client to POS server 120, POS interface server 140 must track certain state information in order to correctly represent each of thin client devices 130 to POS server 120. Maintenance of state information on thin client devices 130 as well may be redundant in such an embodiment.

In the embodiment of FIG. 2, access control module 230 determines whether thin client devices 130 are authorized to access POS server 120. A unique device identifier is received from each thin client device. In an embodiment, the unique identifier is sent by the thin client device along with user login information entered by the user of the device. In some embodiments, the device identifier is a character string that uniquely identifies a thin client device, such as a serial number. For example, in embodiments for which a thin client device uses certain versions of the iOS® operating system, the Apple Universal Device ID or UDID can be used as the device identifier. The device identifier must be unique from the standpoint of the POS server application, and in some embodiments is assigned to be unique for a given application vendor.

Access control module 230 compares a received device identifier to identifiers stored in device profiles 250 corresponding to authorized thin client devices. A device profile 250 for a thin client device includes a mappings portion 260 for mapping the device identifier for that thin client device to a register number, or sales terminal number, recognized by POS server 120. (“Register” in this case is used in the sense of “cash register” rather than in the sense of registration of the device.) In certain embodiments, the device identifier is also mapped to an identifier for the store (or other retail environment) the device is assigned to. In an embodiment, initial mapping of device identifiers for authorized devices to register and store numbers is done by an administrator for POS interface server 140. Each of device profiles 250 also includes a settings portion 270 for mapping a device identifier to settings and configuration information for use by the device in carrying out POS transactions. In some embodiments, identical settings are provided to all thin client devices. Alternatively, some or all of the settings and configuration information can be specific to each authorized device. As one example, in an embodiment allowing more than one model of thin client device to be used, settings and configuration information can be specific to each device model.

In certain embodiments, settings portion 270 of device profiles 250 includes POS parameters such as whether credit cards or gift cards are accepted, or how long the terminal can be inactive before the transaction is “timed out.” Because the capabilities and user interface of a thin client device 130 may be limited compared to a more traditional POS terminal, the POS parameters included in settings portion 270 may be only a subset of those available for use by POS server 120. In an embodiment, an administrator for POS interface server 140 selects the POS parameters to be included in settings portion 270. Another type of information included in settings portion 270 in some embodiments is reason codes, which may be entered during a POS transaction to provide explanation for particular actions. In an embodiment, reason codes are customized for a particular installation of POS server 120. The reason codes to be included in settings portion 270 can be selected by an administrator for POS interface server 140, for example. Other kinds of configuration settings can also be included in settings portion 270. In an embodiment, such configuration settings can also be customized for a particular POS installation.

In some embodiments, device profiles 250 could map certain settings to particular users, in addition to mapping settings to devices. In such an embodiment, a device profile could include sub-profiles associated with particular users of that device. Certain settings—for example, whether returns or gift card transactions are permitted—might depend on the experience or seniority of the user. In an embodiment for which a thin client device is used at a particular location in the store (or other retail environment), the profile for that device can include the location of use. Such a profile allows configuration of certain parameters based on location. For example, a device in use in a higher-traffic location of the store might have settings allowing only sales transactions, while a device in a less busy area might have capability for returns, inventory lookups, or report generation. Such location-dependent configuration could be particularly suitable for fixed-location terminals being used in a thin-client mode, though in some embodiments a mobile device can also be used in a relatively fixed location in a store.

In some embodiments, device profiles 250 are also used for configuration of thin client devices based on the type of device. For example, profiles for mobile devices can include more aggressive security settings in terms of how often a user must log in or how rapidly a transaction is ended for inactivity. In an embodiment, thin client devices particularlythose implemented with mobile devices—are tagged for use with a retail location's inventory control system. In such an embodiment, the corresponding device profile includes an identifier or other information associating the device with the inventory system. An interface between the POS interface server and the inventory control system then provides rapid notification if a device is removed from the store, so that the device can be promptly removed from the group of authorized devices. In some embodiments for which a thin client device is implemented with a mobile device, device profiles 250 include information allowing location of the device using location services based on, for example, cellular, Wi-Fi, or global positioning system (GPS) networks. In certain such embodiments, a thin client device can be disabled or erased, once the device is located or a determination is made that the device has left a certain (e.g., predefined) area, such as the commercial location.

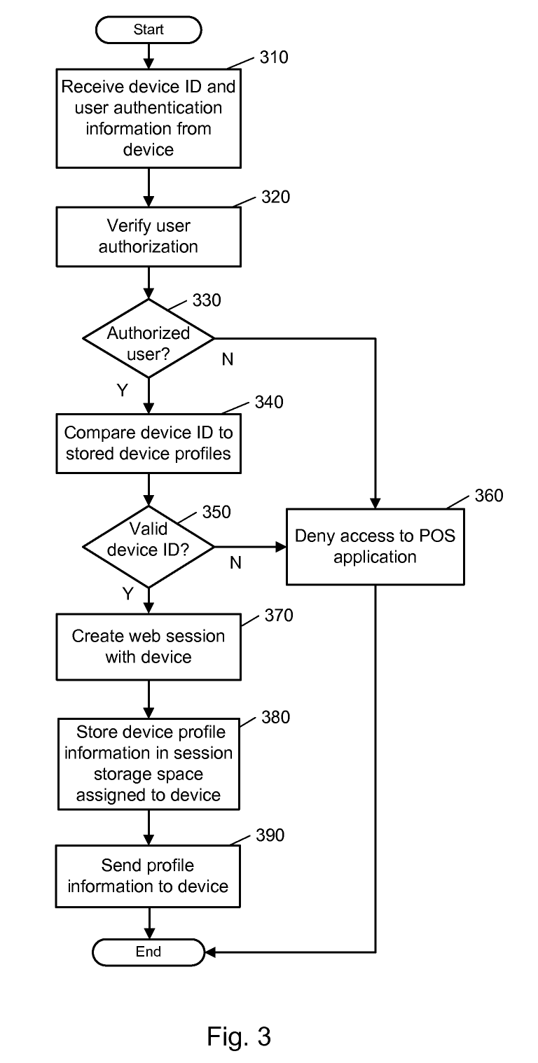

Session control module 240 manages the interactions between thin clients 130 and POS server 120, assuming authorization of the device and its user is successful and the device is allowed access to POS server 120. As described further below with reference to FIG. 3, both the thin client device and its user must be authorized for access to be granted. In an embodiment, POS interface server 140 grants access to POS server 120 by creating a web session between the authorized thin client device 130 and POS server 120. Session control module 240 is configured to manage the web session in such an embodiment, in part by keeping track of the state of objects representing important elements. Session storage space 280 includes a separate space allocation 285 for each authorized device. Information relevant to each device's session with POS server 120 is stored in that device's allocated session space. In an embodiment, the stored information includes some or all of the information from the device's profile in device profiles 250, such as the register number and store number corresponding to the device. Information stored in session space 285 for a device can also include, for example, identifiers of the device's operator or user, the current retail transaction, and/or the most recently completed transaction.

Tracking of state by POS interface server 140 (through session control module 240) facilitates interaction with a “thin” client having a more limited POS client application. Because multiple thin client devices can be connected to POS server 120 through POS interface server 140, session control module 240 also tracks state to ensure that POS server 120 associates transaction information with the correct register or terminal. In an embodiment, an error code entered at a thin client device is associated with the register number for the device so that errors can be sorted by register for handling.

In an embodiment, POS interface server application 140 acts as a client to POS server 120. In such an embodiment POS interface server 140 may include functionality similar to POS client applications that may run on POS client terminals 110. To provide an interface for multiple thin client devices 130, POS interface server must handle multiple threads of execution. This is in contrast to a POS client application on POS client terminal 110, which generally handles only a single user interface and transaction at a time.

POS interface server 140 may include additional modules and provide additional services or functions to those shown in the block diagram of FIG. 2. In an embodiment, such additional functions include register operations, item lookup operations, and/or execution of other POS business logic. In a further embodiment execution of POS business logic could include interaction with a POS tour engine used by POS server 120 to process transactions for multiple networked registers or terminals. “Module” is used in FIG. 2 in a general sense to indicate and highlight a particular functionality of POS interface server 140, and is not intended as a requirement that the modules in FIG. 2 be independently-developed portions of code, for example. Modules 220, 230, and 240 of FIG. 2 should be understood to interact with one another in implementing POS interface server 140. Arrows between a particular module and another element of FIG. 2 are intended to illustrate significant connections but are not intended to indicate that no other modules can interact with a given element. Various alternatives to the layout of FIG. 2 may be apparent to one of ordinary skill in the art in view of the teachings of this disclosure. For example, one or both of device profiles 250 or session storage space 280 may in some embodiments be within POS database 150. One or both of device profiles 250 or session storage space 280 could in some embodiments be stored on a different computer system than POS interface server 140.

### Example Processes

An embodiment of a device access control method is illustrated by the flow chart of FIG. 3. The method of FIG. 3 may be carried out by a POS interface server such as POS interface server 140 of FIGS. 1 and 2. In such an embodiment, the POS interface server receives a user ID, password, and device ID from a device such as thin client device 130 (step 310). The device ID identifies the device uniquely, at least with respect to the POS interface server and a POS server such as POS server 120 of FIGS. 1 and 2. In an embodiment, the device ID uniquely identifies the device with respect to a vendor of the POS interface server and POS server. In a further embodiment, the device ID uniquely identifies the device across all vendors and applications. The device ID may also be referred to as a hardware ID. In an embodiment, one or more of the device ID, user ID and password are transmitted in a hashed or otherwise altered form. Any or all of these can be stored in an altered form, also. The POS interface server verifies user authorization (step 320), which can in certain embodiments be accomplished by passing the user ID and password to the POS server for authentication. If the user login information is not valid, access to the POS server application by the device is denied (steps 330, 360).

The POS interface server also compares the device ID to stored device profiles (step 340). In an embodiment, these device profiles are stored on the same computer system as the POS interface server. If the device ID does not correspond to a registered, or authorized, device, access to the POS application is denied (steps 350, 360). If both the user login and the device ID check are valid, the device is allowed to access the POS application. In the embodiment of FIG. 3, a web session is created between the POS interface server and the device (steps 350, 370). Profile information corresponding to the device, such as that from device profiles 250 discussed above, is stored in a session storage space allocated to the device, such as allocated storage space 285 of FIG. 2 (step 380). This stored profile information may be described as “attached” to the session. The profile information is also sent to the device (step 390). Various alternatives to the step sequence of FIG. 3 may be apparent to one of ordinary skill in the art in view of the teachings of this disclosure. For example, the user authorization and device authorization of FIG. 3 would not have to be performed in the order shown. The device authorization could be checked first, or the device and user authorizations could be performed concurrently, particularly if the user verification is done by a different server.

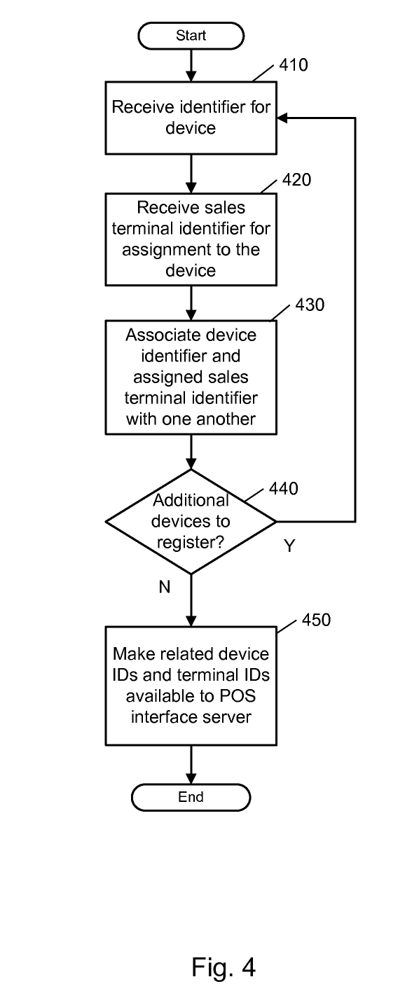

An embodiment of a method for associating a device with an application profile, or registering the device, is illustrated by the flowchart of FIG. 4. The method of FIG. 4 may be carried out by a POS interface server such as POS interface server 140 of FIGS. 1 and 2. Identifiers are received for the device to be registered (step 410), and for the sales terminal (or “register”) that the device is to be assigned to (step 420). The sales terminal identifier is used by a POS server such as POS server 120 to identify terminals involved in POS transactions. In an embodiment, the device and register identifiers are entered by an administrator for the POS interface server. The device identifier and corresponding register identifier are related to, or associated with, one another (step 430). The identifiers can be related through storage in an appropriate data structure. In an embodiment, the device ID and register ID are related using the Java® Map interface. Any additional device identifiers and corresponding sales terminal identifiers received are similarly related to one another (“yes” branch of decision box 440), and the related device IDs and register IDs are made available to the POS interface server (steps 440, 450). In an embodiment, the related device and register identifiers are made available to the POS interface server through storage into a device profile, such as storage into mappings portion 260 of device profiles 250. In some embodiments for which the device and register identifiers are related to one another by storage into a device profile, the relating of step 430 also makes the related identifiers available to the POS interface server.

In an embodiment of the method of FIG. 4, a graphical user interface is provided for use by an administrator to enter device identifiers and corresponding register identifiers. In an alternative embodiment, the device and register identifiers are coded directly into mappings portion 260 of device profiles 250, as part of implementing the POS interface server. In a further embodiment of the method, each of the device identifiers is associated with a store identifier in addition to a register identifier. As with the device and register identifiers, a store identifier is entered into a graphical user interface by an administrator in one embodiment. In an alternative embodiment, the store identifier is coded directly into the device profiles along with the device and register identifiers during implementation of the POS interface server. In an embodiment, the store identifier and register identifier are paired within a Java® bean mapped to the corresponding device identifier using the Java® Map interface. For purposes of clarity, the flow diagram of FIG. 4 illustrates a sequential process of relating each device identifier to its corresponding register identifier one at a time. It should be understood that in some embodiments multiple device identifier/register identifier pairs are received at the same time. This can occur, for example, through entry into a user interface allowing input of multiple device identifiers and corresponding register identifiers. Multiple device identifiers and corresponding register identifiers can also be stored concurrently by directly coding them into device profiles 250 and then saving an updated device profiles file.

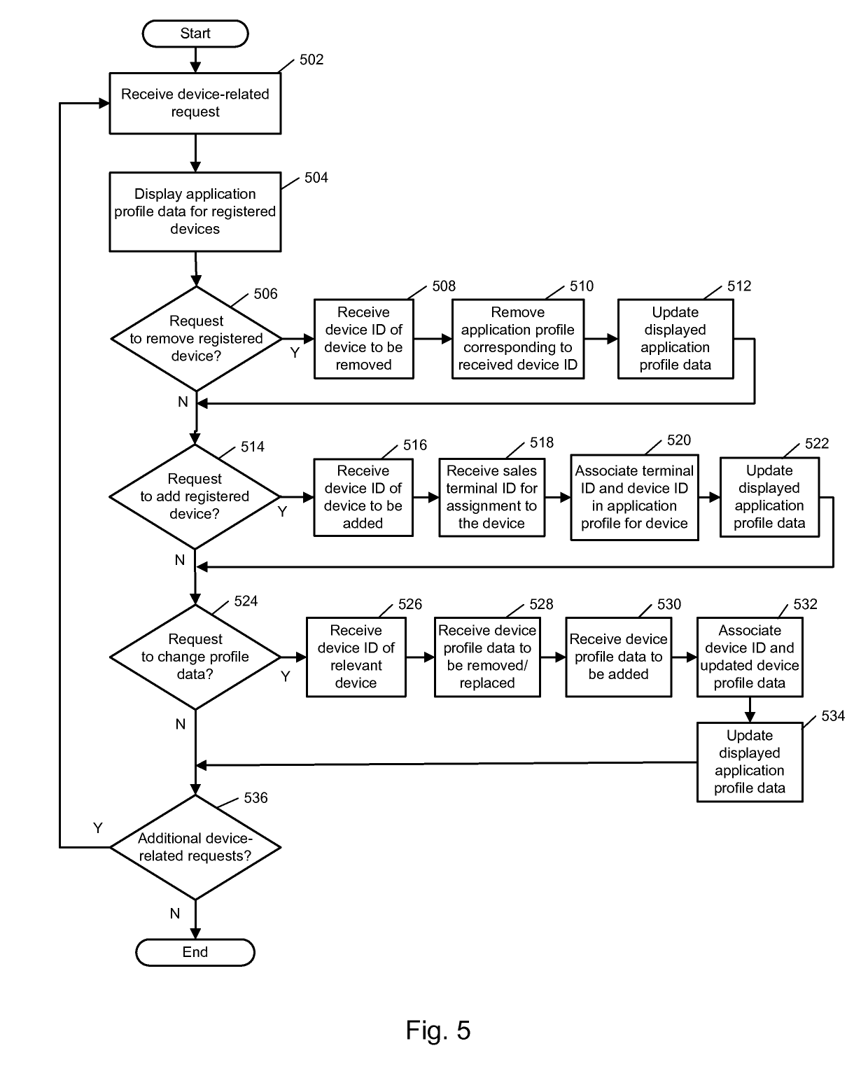

FIG. 5 illustrates an embodiment of a method for modifying the registered devices or their profiles. In an embodiment, the method of FIG. 5 is carried out by a POS interface server such as POS interface server 140 of FIGS. 1 and 2. Upon receipt of a device-related request, the application profile data for registered devices is displayed (steps 502, 504). In the embodiment of FIG. 5, device-related requests include a request to remove a registered device, a request to add a registered device, and a request to change profile data for a device. In the case of a request to remove a registered device (whether manual or automated), the device ID of the device is received (steps 506, 508). The application profile corresponding to the received device ID is removed from device profiles 250 (step 510). In the embodiment of FIG. 5, the displayed application profile data is then updated (step 512). For a request to add a registered device, the device ID and a sales terminal ID corresponding to the device to be added are received (steps 514, 516, 518). The device ID and sales terminal ID are related to one another in the application profile for the device within device profiles 250 (step 520). The device ID and register ID can be related to one another and included in device profiles 250 in the same manner described further above in the discussion of FIG. 4. The displayed application profile data is then updated (step 522).

In the case of a request to change profile data for a currently-registered device, the ID of the device is received, along with the profile data to be removed, replaced, and/or added (steps 524, 526, 528, 530). The device profile is then modified and the updated device profile data is related to the device ID in device profiles 250 (step 532). Relating the device ID to the profile data within device profiles 250 can be done in a similar manner as described above in the discussion of FIG. 4. The displayed application profile data is then updated (step 534). In the embodiment of FIG. 5, requests and data can be received from an administrator of POS interface server 140 through a graphical user interface. Such a graphical user interface can also be used to display application profile data to the administrator. It should be noted that in an alternative embodiment modification of the registered devices or their profiles can be done through direct editing of device profiles 250 by appropriate authorized personnel.

As noted above, the device related requests received in the method of FIGS. 4 and 5 are in some embodiments entered manually, by, for example, an administrator of a POS interface server such as POS interface server 140. In other embodiments, the requests are generated automatically. Such an automatic request can in some embodiments be generated in response to presence or absence of a signal related to a POS device. For example, in certain embodiments a POS device can send a periodic status signal (i.e., a “heartbeat” signal) to POS interface server 140, over either a wired or wireless connection. In such an embodiment, absence of a device's status signal for a certain number of signal periods can trigger a de-registration of the device. This de-registration can result from generation of a device removal request as shown in FIG. 5. In an alternative embodiment, a wireless access point within the retail environment can signal to the POS interface server that connection with a POS device has been lost, triggering a device removal request. In an embodiment for which the POS device is compatible with a retail location's inventory control system, a signal from the inventory control system indicating that a device has left the store can be used to trigger a device removal request.

As an alternative to the more permanent device de-registration illustrated in FIG. 5, in which the application profile for a device is removed or deleted, a device can be temporarily denied access to a POS server application such as POS server 120. For example, a web session with a device, as discussed above in connection with FIG. 3, can be ended so that the device is required to go through the login/authorization process again before it can be used. In certain embodiments, a request to change profile data for a device, as illustrated in FIG. 5, can arrive while that device is actively connected to a POS server such as POS server 120, via a POS interface server such as POS interface server 140. In such an embodiment, the device can be logged out and required to log in again after the profile data has been changed. As an example, a request to change profile data can be automatically generated in an embodiment for which a retail location has multiple wireless access points that are used to determine the location of a POS device using one or more of the access points to connect to a network. In such an embodiment, a determination that a device has been moved to a different location within the retail environment can result in a request to change the profile data associated with that device. As noted above in the discussion of FIG. 2, device profiles can include location information in some embodiments, and certain parameters within the profiles may be set depending on the location of the device. In some embodiments, multiple alternative profiles or subprofiles are associated with a device, corresponding to different locations of use and/or users of the device. In some cases, use of a device in a particular location may be restricted to particular users. In such an embodiment, ending of an active session in response to detection of a new device location allows the user authorization to be checked again during the next login process, which locates a device profile or subprofile corresponding to the new location.

Various alternatives to the methods of FIGS. 3-5 may be apparent to one of ordinary skill in the art in view of the teachings of this disclosure. For example, in embodiments of the method of FIG. 5 in which a device-related request is generated automatically rather than manually, the displaying and updating of data as shown in steps 504, 512, 522, and 532 can be omitted.

### An Example Computing and Network Environment

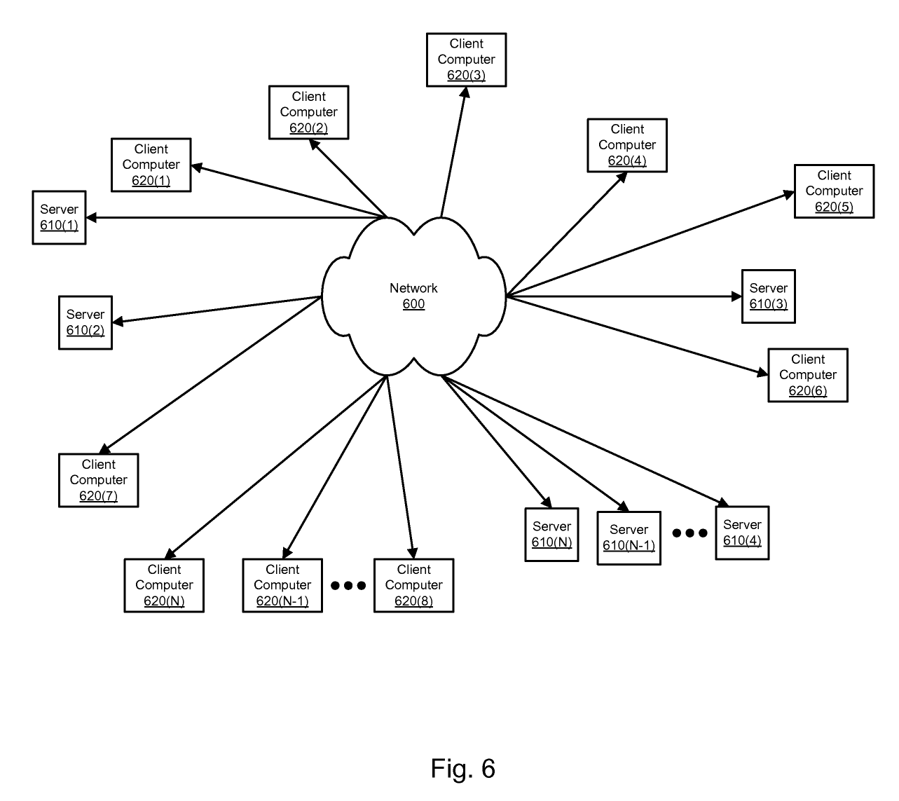

FIG. 6 is a block diagram illustrating a network environment in which a system such as that of FIGS. 1 and 2 may be practiced. As is illustrated in FIG. 6, network 600, such as a private wide area network (WAN) or the Internet, includes a number of networked servers 610(1)-(N) that are accessible by client computers 620(1)-(N). Communication between client computers 620(1)-(N) and servers 610(1)-(N) may occur over a publicly accessible network, such as a public switched telephone network (PSTN), a DSL connection, a cable modem connection or large bandwidth trunks (e.g., communications channels providing T1 or OC3 service). Such networks may also include cellular or mobile telephone networks and other wireless networks such as those compliant with the IEEE 802.11 standards. Client computers 620(1)-(N) access servers 610(1)-(N) through, for example, a service provider. This might be, for example, an Internet Service Provider (ISP). Access is typically had by executing application specific software (e.g., network connection software and a browser) on the given one of client computers 620(1)-(N).

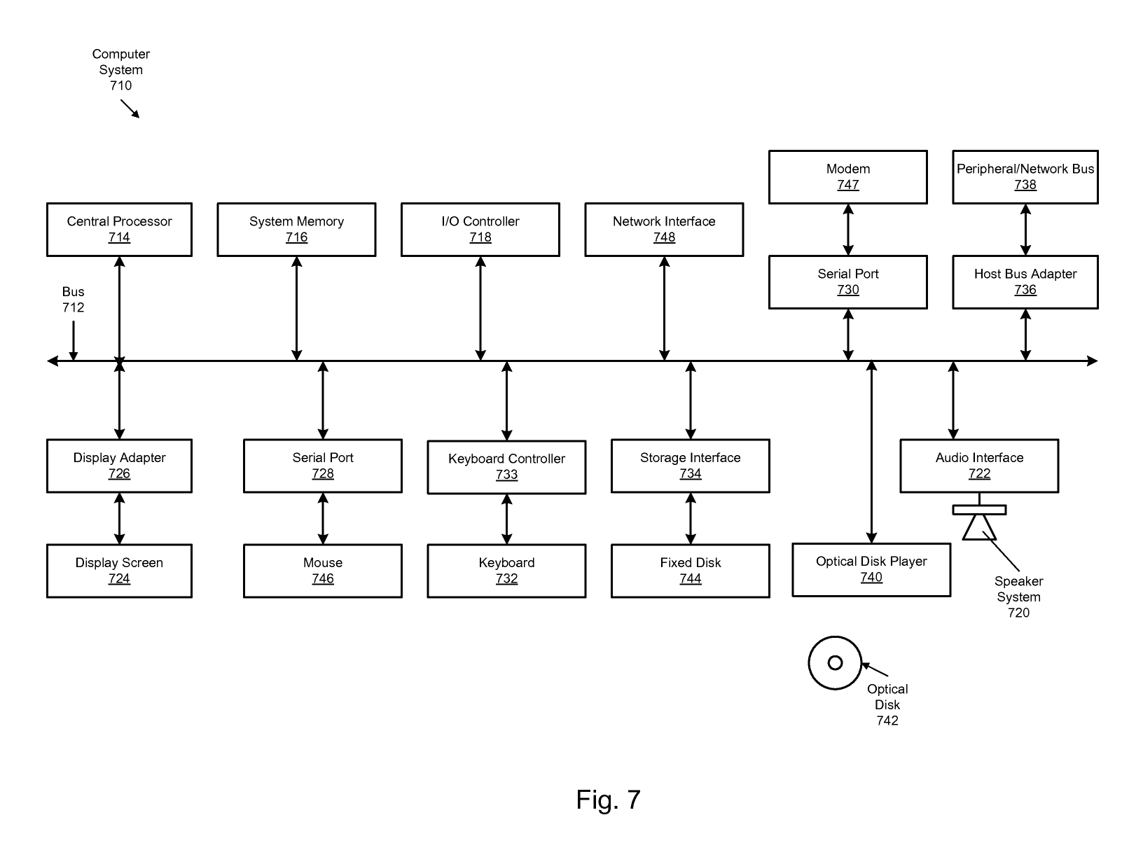

One or more of client computers 620(1)-(N) and/or one or more of servers 610(1)-(N) may be, for example, a computer system of any appropriate design, in general, including a mainframe, a mini-computer or a personal computer system. Such a computer system typically includes a system unit having a system processor and associated volatile and non-volatile memory, one or more display monitors and keyboards, one or more disk drives, one or more fixed storage devices and one or more printers. These computer systems are typically information handling systems which are designed to provide computing power to one or more users, either locally or remotely. Such a computer system may also include one or a plurality of I/O devices (i.e., peripheral devices) which are coupled to the system processor and which perform specialized functions. Examples of I/O devices include modems, sound and video devices and specialized communication devices. Mass storage devices such as hard disks, CD-ROM drives, solid state drives, flash drives, and magneto-optical drives may also be provided, either as an integrated or peripheral device. One such example computer system, discussed in terms of client computers 620(1)-(N) is shown in detail in FIG. 7.

It will be noted that the variable identifier “N” is used in several instances in FIG. 6 and other figures herein to more simply designate the final element (e.g., servers 610(1)-(N) and client computers 620(1)-(N)) of a series of related or similar elements (e.g., servers and client computers). The repeated use of such variable identifiers is not meant to imply a correlation between the sizes of such series of elements, although such correlation may exist. The use of such variable identifiers does not require that each series of elements has the same number of elements as another series delimited by the same variable identifier. Rather, in each instance of use, the variable identified by “N” may hold the same or a different value than other instances of the same variable identifier.

FIG. 7 depicts a block diagram of a computer system 710 suitable for implementing components of the systems described herein, for example as local computer system 105, one or more of POS client terminals 110(1)-(N), one or more of thin client devices 130(1)-(N), and/or one or more of client computers 620(1)-(N). Computer system 710 includes a bus 712 which interconnects major subsystems of computer system 710 such as a central processor 714, a system memory 716 (typically RAM, but which may also include ROM, flash RAM, or the like), an input/output controller 718, an external audio device such as a speaker system 720 via an audio output interface 722, an external device such as a display screen 724 via display adapter 726, serial ports 728 and 730, a keyboard 732 (interfaced with a keyboard controller 733), a storage interface 734 interfaced with a fixed disk 744, such as a hard disk drive or solid state drive, a floppy disk drive 736 operative to receive a floppy disk 738, and an optical drive 740 operative to receive an optical disk 742. One or more host bus adapters 736 may be used to connect to one of various peripheral or network buses, such as SATA/ATA, SAS/SCSI, USB, Fibre Channel, etc. Also included in the example of FIG. 7 are a mouse 746 (or other point-and-click device, coupled to bus 712 via serial port 728), a modem 747 (coupled to bus 712 via serial port 730) and a network interface 748 (coupled to bus 712).

Bus 712 allows data communication between central processor 714 and system memory 716, which may include both read only memory (ROM) or flash memory (neither shown), and random access memory (RAM) (not shown), as previously noted. The RAM is generally the main memory into which the operating system and application programs are loaded and typically affords at least 16 megabytes of memory space. The ROM or flash memory may contain, among other code, the Basic Input-Output system (BIOS) which controls basic hardware operation such as the interaction with peripheral components. Applications resident with computer system 710 are generally stored on and accessed via a computer readable storage medium, such as a hard disk drive (e.g., fixed disk 744), an optical drive (e.g., optical drive 740), USB flash drive or other storage medium. An application used by computer system 710 may also be resident on another computer accessible via a network, or distributed over multiple networked computers.

Storage interface 734, as with the other storage interfaces of computer system 710, may connect to a standard computer readable storage medium for storage and/or retrieval of information, such as a fixed disk drive 744. Fixed disk drive 744 may be a part of computer system 710 or may be separate and accessed through other interface systems. Additional devices can be connected such as a mouse 746 connected to bus 712 via serial port 728, a modem 747 connected to bus 712 via serial port 730 and a network interface 748 connected directly to bus 712. Many other devices or subsystems (not shown) may be connected in a similar manner (e.g., bar code readers, document scanners, digital cameras, flash memory drives and so on). Conversely, it is not necessary for all of the devices shown in FIG. 7 to be present to practice the present invention. The devices and subsystems may be interconnected in different ways from that shown in FIG. 7. Modem 747 may provide a direct connection to a remote server via a telephone link or to the Internet via an internet service provider (ISP). Network interface 748 may provide a direct connection to a remote server via a direct network link to the Internet via a POP (point of presence). Network interface 748 may provide such connection using wireless techniques, including digital cellular telephone connection, Cellular Digital Packet Data (CDPD) connection, digital satellite data connection or the like.

The operation of a computer system such as that shown in FIG. 7 is readily known in the art and is not discussed in detail in this application. Code to implement the systems and methods described herein may be stored in computer-readable storage media such as one or more of system memory 716, fixed disk 744, or optical drive 742. Additionally, computer system 710 may be any kind of computing device, including personal data assistants (PDAs), network appliances, X-window terminals, mobile telephones (e.g., “smartphones”), personal media players, portable gaming systems, tablets or laptop computers, or other such computing devices. The operating system provided on computer system 710 may be MS-WINDOWS®, UNIX®, Linux®, iOS®, Android® or other known operating system. Computer system 710 also supports a number of Internet access tools, including, for example, an HTTP-compliant web browser having a JavaScript interpreter, such as Mozilla Firefox®, Microsoft Internet Explorer® and the like.

It should further be noted that a client such as 620(1)-(N) of FIG. 6 or server such as 610(1)-(N) of FIG. 6 may be implemented as a “virtual machine” within computer system 710 using partitioning techniques known in the art. In such an implementation, a computer system such as system 710 may include one or more of clients 620(1)-(N) and servers 610(1)-(N).

Moreover, regarding the signals described herein, those skilled in the art will recognize that a signal may be directly transmitted from a first block to a second block, or a signal may be modified (e.g., amplified, attenuated, delayed, latched, buffered, inverted, filtered or otherwise modified) between the blocks. Although the signals of the above described embodiment are characterized as transmitted from one block to the next, other embodiments of the present invention may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing described embodiment includes different components contained within different other components (e.g., the various elements shown as components of computer system 710). It is to be understood that such depicted architectures are merely examples, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality.

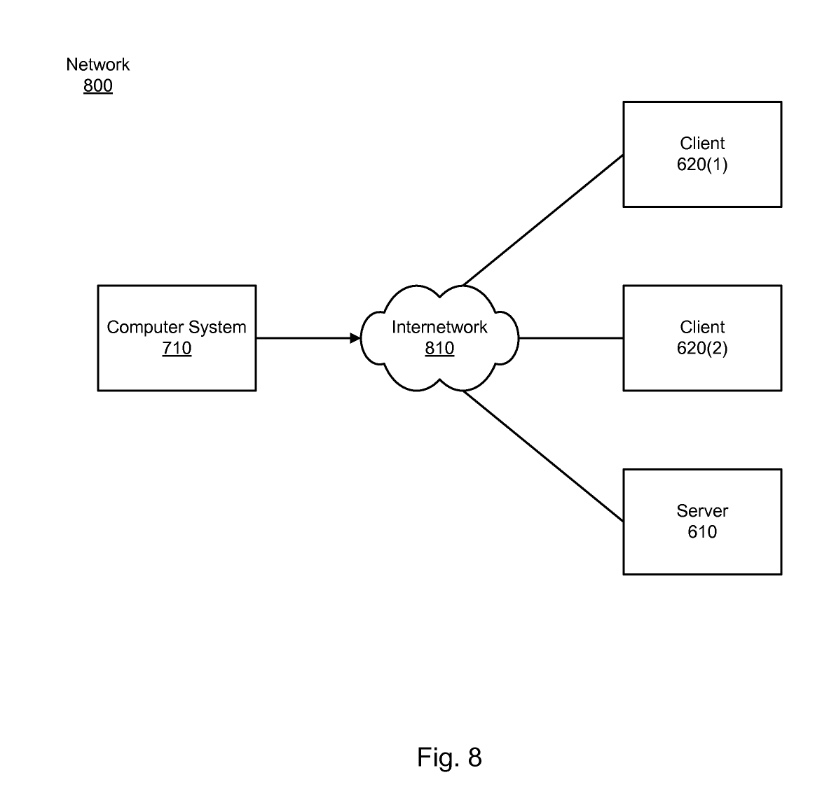

FIG. 8 is a block diagram depicting a network 800 in which computer system 710 is coupled to an internetwork 810, which is coupled, in turn, to client systems 620(1) and 620(2), as well as a server 610. Internetwork 810 (e.g., the Internet) is also capable of coupling client systems 620(1) and 620(2), and server 610 to one another. With reference to computer system 710, modem 747, network interface 748 or some other method can be used to provide connectivity from computer system 710 to internetwork 810. Computer system 710, client system 620(1) and client system 620(2) are able to access information on server 610 using, for example, a web browser (not shown). Such a web browser allows computer system 710, as well as client systems 620(1) and 620(2), to access data on server 610 representing the pages of a website hosted on server 610. Protocols for exchanging data via the Internet are well known to those skilled in the art. Although FIG. 8 depicts the use of the Internet for exchanging data, the present invention is not limited to the Internet or any particular network-based environment.

Referring to FIGS. 6, 7 and 8, a browser running on computer system 710 employs a TCP/IP connection to pass a request to server 610, which can run an HTTP “service” (e.g., under the WINDOWS® operating system) or a “daemon” (e.g., under the UNIX® operating system), for example. Such a request can be processed, for example, by contacting an HTTP server employing a protocol that can be used to communicate between the HTTP server and the client computer. The HTTP server then responds to the protocol, typically by sending a “web page” formatted as an HTML file. The browser interprets the HTML file and may form a visual representation of the same using local resources (e.g., fonts and colors).

As noted, FIGS. 3-5 depict flow diagrams illustrating processes according to certain embodiments of the methods described herein. It is appreciated that operations discussed herein may consist of directly entered commands by a computer system user or of steps executed by application specific hardware modules as alternative embodiments to steps executed by software modules. The functionality of steps referred to herein may correspond to the functionality of modules or portions of modules.

The operations referred to herein may be modules or portions of modules (e.g., software, firmware or hardware modules). For example, although the described embodiment includes software modules and/or includes manually entered user commands, the various example modules may be application specific hardware modules. The software modules discussed herein may include script, batch or other executable files, or combinations and/or portions of such files. The software modules may include a computer program or subroutines thereof encoded on computer-readable storage media.

Additionally, those skilled in the art will recognize that the boundaries between modules are merely illustrative and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, those skilled in the art will recognize that the operations described in example embodiment are for illustration only. Operations may be combined or the functionality of the operations may be distributed in additional operations in accordance with the invention.

Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the steps of the flow diagram may be executed by a module (e.g., a software module) or a portion of a module or a computer system user using, for example, a computer system such as computer system 710. Thus, the above described method, the operations thereof and modules therefor may be executed on a computer system configured to execute the operations of the method and/or may be executed from computer-readable storage media. The method may be embodied in a machine-readable and/or computer-readable storage medium for configuring a computer system to execute the method. Thus, the software modules may be stored within and/or transmitted to a computer system memory to configure the computer system to perform the functions of the module, for example.

Such a computer system normally processes information according to a program (a list of internally stored instructions such as a particular application program and/or an operating system) and produces resultant output information via I/O devices. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Such a computer system typically includes multiple computer processes executing “concurrently.” Often, a computer system includes a single processing unit which is capable of supporting many active processes alternately. Although multiple processes may appear to be executing concurrently, at any given point in time only one process is actually executed by the single processing unit. By rapidly changing the process executing, a computer system gives the appearance of concurrent process execution. The ability of a computer system to multiplex the computer system's resources among multiple processes in various stages of execution is called multitasking. Systems with multiple processing units, which by definition can support true concurrent processing, are called multiprocessing systems. Active processes are often referred to as executing concurrently when such processes are executed in a multitasking and/or a multiprocessing environment.

The software modules described herein may be received by such a computer system, for example, from computer readable storage media. The computer readable storage media may be permanently, removably or remotely coupled to the computer system. The computer readable storage media may non-exclusively include, for example, any number of the following: magnetic storage media including disk and tape storage media; optical storage media such as compact disk media (e.g., CD-ROM, CD-R, etc.) and digital video disk storage media; nonvolatile memory storage memory including semiconductor-based memory units such as FLASH memory, EEPROM, EPROM, ROM or application specific integrated circuits; volatile storage media including registers, buffers or caches, main memory, RAM, and the like; and other such computer-readable storage media. In a UNIX-based embodiment, the software modules may be embodied in a file which may be a device, a terminal, a local or remote file, or other such devices. Other new and various types of computer-readable storage media may be used to store the software modules discussed herein.

While particular embodiments have been shown and described, it will be obvious to those skilled in the art that, based upon the teachings herein, changes and modifications may be made without departing from this invention and its broader aspects and, therefore, the appended claims are to encompass within their scope all such changes and modifications.

What is claimed is:

1. A method comprising:
receiving a device identifier, wherein
the device identifier is configured to uniquely identify a device;
in response to the receiving the device identifier, determining whether the device is authorized to access a retail point-of-service application, wherein the determining uses the device identifier; and
in response to a determination that the device is authorized,
allowing the device access to the point-of-service application, and
providing the device with application profile information for the point-of-service application, wherein
the application profile information is specific to the device.

2. The method of claim 1, further comprising:
receiving from the device a user identifier and a password, wherein the user identifier and password are entered into the device by a user;
executing a user authorization process to determine whether the user is authorized to access the retail point-of-service application; and
in response to a determination that the user is not authorized, denying access to the point-of-service application, wherein said allowing access to the point-of-service application is further in response to a determination that the user is authorized to access the point-of-service application.

3. The method of claim 1, wherein
said allowing access comprises creating a web session between a point-of-service server and the device.

4. The method of claim 3, wherein said creating a web session comprises:
storing the application profile information in a session storage space allocated to the device.

5. The method of claim 1, wherein said receiving a device identifier comprises:
receiving the device identifier from a mobile device.

6. The method claim 1, wherein
said determining comprises comparing the received device identifier to one or more stored authorized device identifiers.

7. The method of claim 1, wherein
said receiving a device identifier occurs during an initial connection from the mobile device to a web server.

8. The method of claim 1, wherein said receiving a device identifier comprises:
receiving the device identifier via a wireless connection.

9. The method of claim 1, wherein said application profile information comprises:
settings for operation of the device.

10. The method of claim 1, wherein
said application profile information relates the device identifier to a register number recognized by the point-of-service application.

11. The method of claim 1, wherein
said application profile information relates the device identifier to a store number of a store in which the point-of-service application is configured to operate.

12. The method of claim 1, wherein said receiving a device identifier comprises:
receiving a device identifier transmitted using a hypertext transfer protocol.

13. The method of claim 1, further comprising:
in response to a determination that the mobile device is not authorized, denying access to the point-of-service application.

14. An apparatus, comprising:
a processor;
a network interface configured for communication with a point-of-service device; and
a point-of-service interface application configured to
receive a device identifier, wherein
the device identifier is configured to uniquely identify the point-of-service device,
in response to receipt of the device identifier, determine whether the point-of-service device is authorized to access a retail point-of-service application, wherein
the point-of-service application is further configured to use the device identifier in determining whether the point-of-service device is authorized, and
in response to a determination that the point-of-service device is authorized,
allow access to the point-of-service application by the point-of-service device, and
provide the point-of-service device with application profile information for the point-of-service application, wherein
the application profile information is specific to the point-of-service device.

15. The apparatus of claim 14, wherein the point-of-service interface application is further configured to:
receive from the point-of-service device a user identifier and a password, wherein the user identifier and password are entered into the point-of-service device by a user;
execute a user authorization process to determine whether the user is authorized to access the retail point-of-service application; and
in response to a determination that the user is not authorized, deny access to the point-of-service application.

16. The apparatus of claim 14, wherein the point-of-service interface application is further configured to:
allow access to the point-of-service application by creating a web session between a point-of-service server and the point-of-service device.

17. The apparatus of claim 16, wherein the point-of-service interface application is further configured to:
store the application profile information in a session storage space allocated to the device.

18. The apparatus of claim 14, wherein
the point-of-service interface application is configured to determine whether the device is authorized by comparing the received device identifier to one or more stored authorized device identifiers.

19. A non-transitory computer readable storage medium configured to store program instructions that, when executed on a processor, are configured to cause the processor to perform a method comprising:
receiving a device identifier, wherein
the device identifier is configured to uniquely identify a device;
in response to the receiving the device identifier, determining whether the device is authorized to access a retail point-of-service application, wherein the determining uses the device identifier; and
in response to a determination that the device is authorized,
allowing access to the point-of-service application by the device, and
providing the device with application profile information for the point-of-service application, wherein
the application profile information is specific to the device.

20. The non-transitory computer readable storage medium of claim 19, wherein the method further comprises:
receiving from the device a user identifier and a password, wherein the user identifier and password are entered into the device by a user;
executing a user authorization process to determine whether the user is authorized to access the retail point-of-service application; and
in response to a determination that the user is not authorized, denying access to the point-of-service application.

21. The non-transitory computer readable storage medium of claim 19, wherein
said determining comprises comparing the received device identifier to one or more stored authorized device identifiers.
